(19) United States
(12) Patent Application Publication
(10) Pub. No.: US 2026/0178414 A1
(43) Pub. Date: Jun. 25, 2026

(54) CONTEXT-AWARE AI MODEL SELECTION

(71) Applicant: SK Hynix NAND Product Solutions Corp. (dba Solidigm), Rancho Cordova, CA (US)

(72) Inventors: Samudyatha KAIRA, Portland, OR (US); Rita H. WOUHAYBI, Portland, OR (US); Priyanka MUDGAL, Portland, OR (US)

(21) Appl. No.: 19/000,370

(22) Filed: Dec. 23, 2024

(51) Int. Cl. G06F 9/50; G06N 20/00

(52) U.S. Cl. CPC G06F 9/5055; G06N 20/00; G06F 2209/501; G06F 2209/503

(57) ABSTRACT

A system and method are provided for context-aware selection of artificial intelligence (AI) models. The method includes receiving and automatically labeling input datasets using unsupervised learning techniques and zero-shot models to establish baseline classifications. The system incorporates real-time resource monitoring through a dedicated module that analyzes deployment telemetry data to predict available computational capacity. Using these insights, a context-aware selector identifies appropriate AI models and tasks based on both the labeled data characteristics and resource availability. The method then evaluates the selected models through performance testing on the labeled datasets to generate comprehensive metrics. The system concludes by recommending optimal AI models and corresponding tasks that balance performance requirements with resource constraints. This approach addresses the challenge of efficient AI model selection by implementing an automated pipeline that considers both data context and computational limitations, enabling more intelligent and resource-aware AI deployments.

### BACKGROUND

Artificial Intelligence (AI) models, particularly Large Language Models (LLMs), have undergone rapid evolution and advancement, achieving unprecedented capabilities across diverse tasks. These generalized models have grown increasingly sophisticated, incorporating billions of parameters to handle a wide range of applications including zero-shot classification tasks, which includes the ability to make predictions for classes not encountered during training. While such models demonstrate remarkable versatility, their practical deployment faces significant technical challenges.

A technical problem in the field relates to the trade-off between model size and computational efficiency. Powerful generalized LLMs require substantial computational resources for deployment and operation. For example, models like Meta-Llama-3.1-8B utilize 8 billion parameters, demanding expensive hardware infrastructure and significant computational overhead. This resource intensity makes these models impractical for many enterprise applications, particularly in scenarios requiring real-time responses or deployment at scale. Another technical challenge involves the balance between broad knowledge coverage and specialized expertise. While generalized LLMs offer comprehensive knowledge bases, they may lack domain-specific precision and can be prone to hallucinations (generating plausible but incorrect information). Specialized models, such as BioMedLM with 2.7 billion parameters, demonstrate that targeted expertise can achieve comparable or superior performance with fewer resources in specific domains. However, the growing proliferation of specialized models has introduced new complications in model selection and deployment strategies.

Enterprise environments present additional technical hurdles in implementing AI solutions. Organizations must optimize for both accuracy and efficiency while managing resource constraints. The process of selecting appropriate models, whether general or specialized, has become increasingly complex and time-consuming. For instance, in developing a biomedical chatbot, organizations must evaluate various factors including model size, response accuracy, domain expertise, and computational requirements, while maintaining performance standards and managing infrastructure costs. These technical challenges highlight the need for a systematic approach to leverage the strengths of both generalized and specialized models while addressing their respective limitations. Conventional systems lack efficient mechanisms for automatically identifying, extracting, and deploying optimal model components based on specific use cases and computational constraints.

### SUMMARY

Accordingly, there is a need for systems and methods that address at least some of the problems described above. Embodiments of the present disclosure provide systems and methods for autonomous context-aware selection of artificial intelligence (AI) models. The present disclosure addresses the technical challenges of deploying AI models in enterprise environments, particularly the trade-offs between model size, computational efficiency, and domain expertise. To solve these challenges, the disclosure presents an automated system for model selection and optimization. The system leverages foundation models to generate high-quality labeled datasets, analyzes available computational resources, and systematically evaluates potential AI models from public repositories. Through automated testing and performance analysis against configurable thresholds, the system recommends optimal model architectures and AI tasks tailored to specific use cases and infrastructure constraints. This approach eliminates the manual complexity of model selection while ensuring both computational efficiency and task-specific performance requirements are met.

The disclosed system provides concrete technological improvements to computer functionality by automating and optimizing the complex process of AI model selection and deployment. The system implements sophisticated computational techniques that would be impractical, if not impossible, for humans to perform manually, including real-time analysis of infrastructure resources, systematic evaluation of billions of model parameters, and dynamic performance testing across multiple AI architectures. By automating these resource-intensive computational tasks, the system achieves non-abstract improvements in computer functionality, including reduced computational overhead, optimized resource allocation, and improved model performance. The technology is integrated into practical applications through specific technical steps: automatically generating labeled datasets using foundation models, performing computational resource analysis of existing infrastructure, executing systematic model evaluation from public repositories, and implementing automated performance testing against configurable thresholds. This integration results in concrete technical benefits such as reduced infrastructure costs, improved processing efficiency, and optimized model selection for specific enterprise use cases. The system's ability to dynamically analyze and optimize these complex technical parameters transforms abstract model selection into a concrete technological improvement that enhances the functioning of computing systems themselves.

In one aspect, a method is provided for autonomous context-aware selection of AI models. The method includes obtaining an input dataset, obtaining telemetry data associated with deployment of a plurality of AI models, analyzing the telemetry data to predict available computational resources for deployment of the plurality of AI models, selecting a subset of AI models from the plurality of AI models based on the predicted available computational resources and the input dataset, applying the selected subset of AI models to process the input dataset to determine performance metrics for each of the selected subset of AI models, and recommending one or more AI models to be applied adaptively in the computing system based on the predicted available computational resources and the performance metrics.

In one aspect, a method is provided for autonomous context-aware selection of AI models. The method includes receiving an input data stream for an AI application. The method includes receiving an input dataset. The method also includes labeling the dataset using at least one of unsupervised learning techniques and zero-shot generalized models. The method also includes predicting (e.g., in real-time) available computational resources for model deployment using a resource module that analyzes telemetry data from current and past deployments. The method also includes selecting, using a context-aware model selector, a subset of AI models and corresponding AI tasks based on the labeled dataset and predicted resources. The method also includes testing the selected AI models on the labeled dataset to obtain performance metrics for each selected AI model and corresponding AI task. The method also includes recommending one or more AI models and their corresponding AI tasks based on the performance metrics and resource constraints.

In some embodiments, labeling the dataset includes extracting features from the dataset using a large, generalized embeddings model. The method includes clustering the features using one or more unsupervised learning techniques. The method includes selecting representative data points and outliers from the clusters. The method includes generating labels for the selected data points using a large, generalized foundation model.

In some embodiments, the unsupervised learning techniques include at least one of: centroid-based, distribution-based, and hierarchical clustering algorithms.

In some embodiments, predicting available computational resources includes using a predictive analytics technique (e.g., Long Short-Term Memory (LSTM) network) on telemetry data from past and current deployments in a distributed computing environment.

In some embodiments, selecting the subset of AI models and corresponding AI tasks includes summarizing the labeled dataset using a Large Language Model (LLM) to obtain a summary. The method includes querying the LLM with the summary to return suitable AI models and AI tasks from a plurality of AI model repositories.

In some embodiments, the plurality of AI model repositories includes at least one public repository and one or more public or private repositories.

In some embodiments, testing the selected models includes running each model on the labeled dataset. The method includes calculating performance metrics including F1 score, accuracy, and precision. The method includes comparing the performance metrics to a tunable threshold parameter for acceptable performance.

In some embodiments, the method further includes fine-tuning the recommended model on the input dataset to improve accuracy and reduce hallucinations.

In some embodiments, the method further includes skipping the data labeling step for pre-labeled datasets. The method includes directly inputting the labeled dataset to the context-aware model selector.

In some embodiments, the input dataset includes multimodal data including text, images, and audio, and the data labeling module uses modality-specific feature extractors for different types of data.

In some embodiments, the method further includes dynamically adjusting the selection criteria based on feedback from deployed models and changes in available computational resources.

In some embodiments, the context-aware model selector queries a plurality of public AI model repositories simultaneously.

In some embodiments, the method is applied to data stored on solid-state drives to improve storage performance by providing quality recommendations for model selection based on the stored data.

In some embodiments, the method further includes generating a summary of the labeled dataset using a Large Language Model (LLM). The method includes using the summary to formulate a prompt for querying the context-aware model selector. The method includes ensuring the summary captures nuances critical for model selection using a verification step that checks specificity and relevance of the summary.

In some embodiments, predicting available computational resources includes modeling usage patterns of applications running on a deployment platform. The method includes forecasting resource availability for a specified future time window. The method includes dynamically updating resource predictions based on ongoing model testing and selection processes.

In some embodiments, the method further includes, in accordance with a determination that the input dataset contains data from multiple domains or topics, selecting specialized models for each identified domain. The method includes recommending a combination of generalized and specialized models based on composition of the input dataset.

In another aspect is provided for a system for autonomous context-aware selection of AI models, according to some embodiments. The system includes a data labeling module configured to label input datasets using at least one of unsupervised learning techniques and zero-shot generalized models. The system also includes a resource module configured to predict, in real-time, available computational resources by analyzing telemetry data from current and past deployments in a distributed computing environment. The system also includes a context-aware model selector configured to select suitable AI models and corresponding AI tasks based on the labeled dataset and predicted resources. The system also includes a testing module configured to evaluate selected AI models on the labeled dataset to obtain performance metrics for the corresponding AI tasks. The system also includes a recommendation engine configured to suggest optimal models based on the performance metrics and resource constraints.

In some embodiments, the data labeling module is further configured to extract features using a large, generalized embeddings model, cluster the features using a one or more unsupervised learning techniques, select representative data points and outliers from the clusters, and generate labels for the selected data points using a large, generalized foundation model.

In some embodiments, the resource module uses a predictive analytics technique (e.g., Long Short-Term Memory (LSTM) network) to predict available computational resources.

In some embodiments, the context-aware model selector uses a Large Language Model trained on a plurality of AI model repositories to select suitable models and tasks.

In some embodiments, the testing module is configured to run each selected model on the labeled dataset, calculate performance metrics including F1 score, accuracy, and precision, and compare the performance metrics to a tunable threshold parameter for acceptable performance.

In some embodiments, the system further includes a fine-tuning module configured to improve accuracy and reduce hallucinations of the recommended model on the input dataset.

In some embodiments, the system is further configured to bypass the data labeling module for pre-labeled datasets, and directly feed the labeled dataset to the context-aware model selector.

In some embodiments, the data labeling module is configured to handle multimodal data including text, images, and audio using modality-specific feature extractors.

In some embodiments, the context-aware model selector is configured to generate a summary of the labeled dataset using a Large Language Model (LLM), use the summary to formulate a prompt for querying a plurality of AI model repositories, retrieve information about available models from the plurality of AI model repositories, and select models based on the retrieved model information and relevance of the models to the dataset summary.

In some embodiments, the resource module is configured to model usage patterns of applications running on a deployment platform, forecast resource availability for a specified future time window, and dynamically update resource predictions based on ongoing model testing and selection processes.

In some embodiments, the system is configured to operate in proximity to data storage systems, enabling efficient analysis and model selection for large datasets without requiring data transfer to separate computing resources.

In another aspect, a computing system includes one or more processors, memory, and one or more programs stored in the memory. The programs are configured for execution by the one or more processors. The programs include instructions for performing any of the methods described herein.

In another aspect, a non-transitory computer readable storage medium stores one or more programs configured for execution by one or more processors of a computing system. The programs include instructions for performing any of the methods described herein.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

FIG. 1 is a block diagram of an example system for autonomous context-aware selection of artificial intelligence (AI) models, according to some embodiments.

FIG. 2A is a schematic diagram of an example process for data labeling, according to some embodiments.

FIG. 2B is a schematic diagram of an example process for resource prediction, according to some embodiments.

FIG. 2C is a flow diagram of an example process for context-aware model selection, according to some embodiments.

FIG. 2D shows an example model testing and evaluation process, according to some embodiments.

FIG. 3 shows a block diagram of an example computing device for optimizing artificial intelligence (AI) model selection and loading, according to some embodiments.

FIG. 4 is a flowchart of an example method for autonomous context-aware selection of artificial intelligence (AI) models, according to some embodiments.

FIG. 5 is a flowchart of another example method for autonomous context-aware selection of AI models, according to some embodiments.

Like reference numerals refer to corresponding parts throughout the drawings.

### DESCRIPTION OF IMPLEMENTATIONS

Reference will now be made to various implementations, examples of which are illustrated in the accompanying drawings. In the following detailed description, numerous specific details are set forth in order to provide a thorough understanding of the invention and the described implementations. However, the invention may be practiced without these specific details. In other instances, well-known methods, procedures, components, and circuits have not been described in detail so as not to unnecessarily obscure aspects of the implementations.

This patent application includes examples with specific numerical values to illustrate certain embodiments of the invention. These values are provided solely for illustrative purposes and are neither exhaustive nor restrictive. Their purpose is to aid in understanding the invention and its potential applications. Accordingly, the scope of the invention is not confined to the disclosed numerical values but extends to variations, modifications, interpolations, derivations, and equivalents that would be reasonable to those skilled in the art.

As described above in the Background section, the rapid proliferation of artificial intelligence (AI) models in open-source repositories has transformed the landscape of model selection from a straightforward decision into a complex optimization problem. This complexity stems from the diverse spectrum of available models, ranging from large-scale generalized models to specialized, domain-specific implementations. While generalized models offer robust performance across various tasks due to their extensive pre-training, they often demand substantial computational resources, making them impractical for many real-world deployments with specific constraints. Consider, for example, the healthcare domain where assisted diagnostics for medical imaging presents unique challenges. In X-ray analysis for bone fracture detection, a preliminary approach might utilize generalized image feature extractors like OpenCLIP for initial classification. However, optimal diagnostic accuracy often requires specialized models that incorporate domain-specific knowledge, such as bone density patterns particular to specific anatomical regions (e.g., leg, hand, thigh, hip). This illustrates the fundamental tension between generalized capabilities and specialized expertise in AI model selection. The technical challenges are further compounded by various deployment constraints, including cost limitations for computational resources, strict latency requirements for real-time applications, hardware thermal constraints in edge deployments, memory limitations in resource-constrained environments, and scalability requirements for enterprise-wide solutions.

To address these challenges, this disclosure presents an autonomous system that strategically leverages the strengths of both generalized and specialized models. In some embodiments, the system employs zero-shot recognition capabilities of large, generalized models for initial dataset understanding and unsupervised learning, followed by systematic evaluation and potential training of smaller, specialized models for optimal task-specific performance.

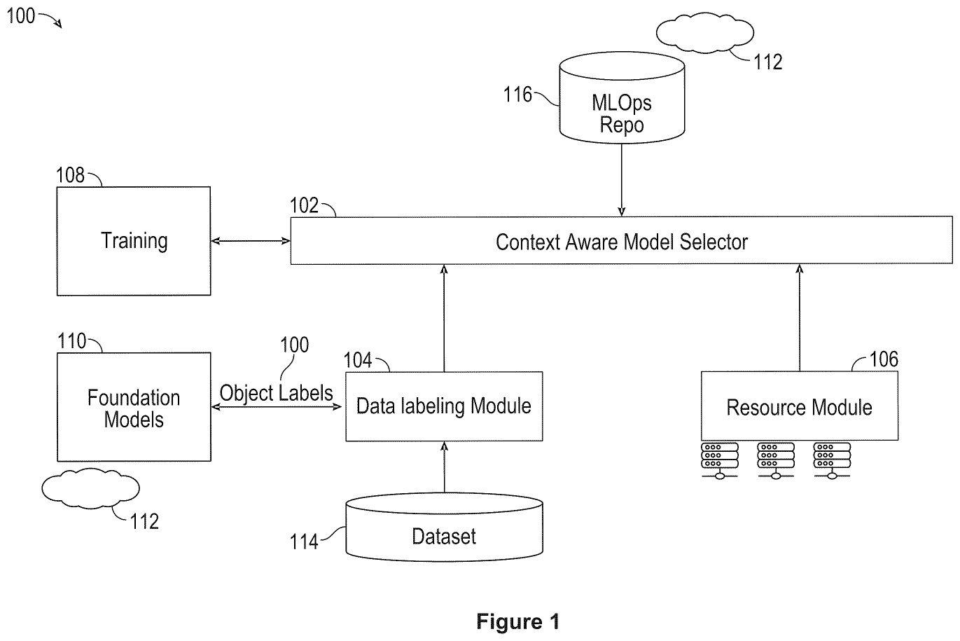

FIG. 1 is a block diagram of an example system 100 for autonomous context-aware selection of artificial intelligence (AI) models, according to some embodiments. A context-aware model selector 102 coordinates the system operations. The system begins with a dataset 114 feeding into a data labeling module 104, which works in conjunction with foundation models 110 (large pre-trained AI models) accessed through a cloud 112 to generate object labels. A resource module 106 monitors and analyzes available computational resources, represented by server racks, and provides this information to the context-aware model selector 102. The context-aware model selector 102 interfaces with a Machine Learning Operations (MLOps) repository 116 through the cloud 112 to access various AI models and configurations. A training module 108 connects to the context-aware model selector 102 to enable model optimization based on the labeled data and selected models. The various components are interconnected through data flows indicated by connecting lines, showing how information moves through the system from initial dataset processing to final model selection and training.

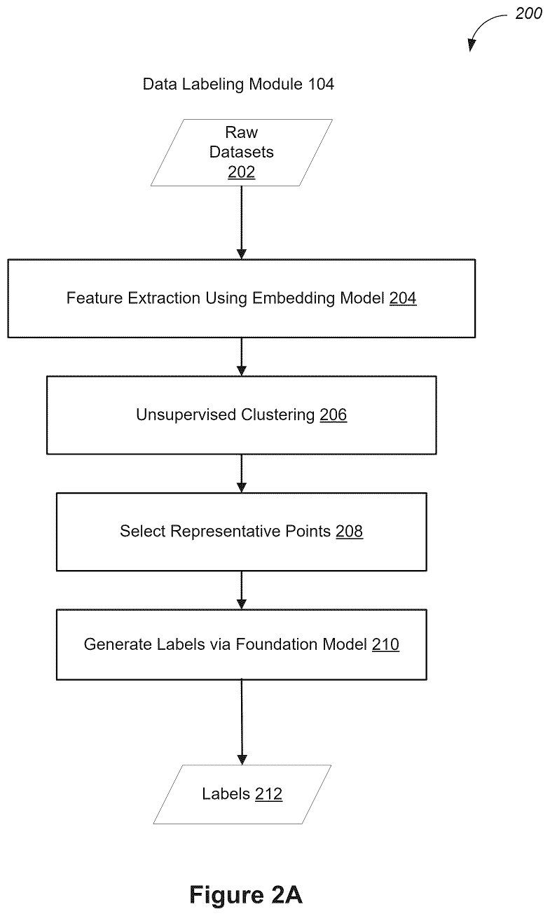

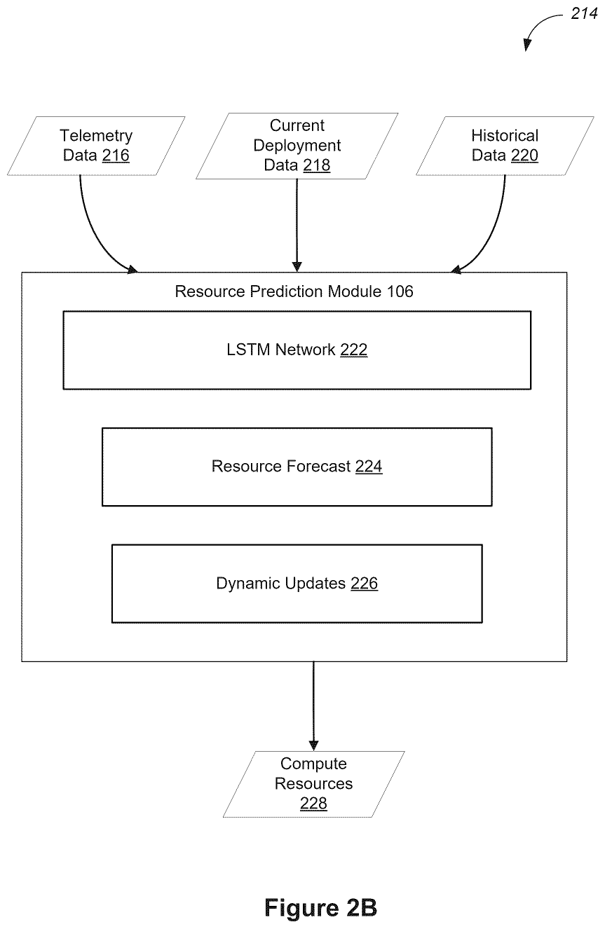

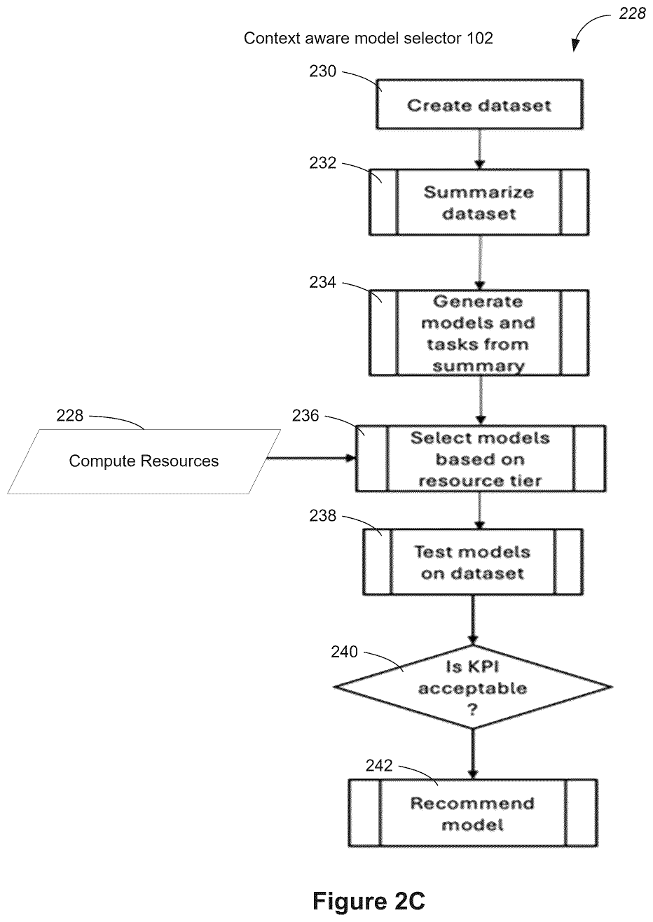

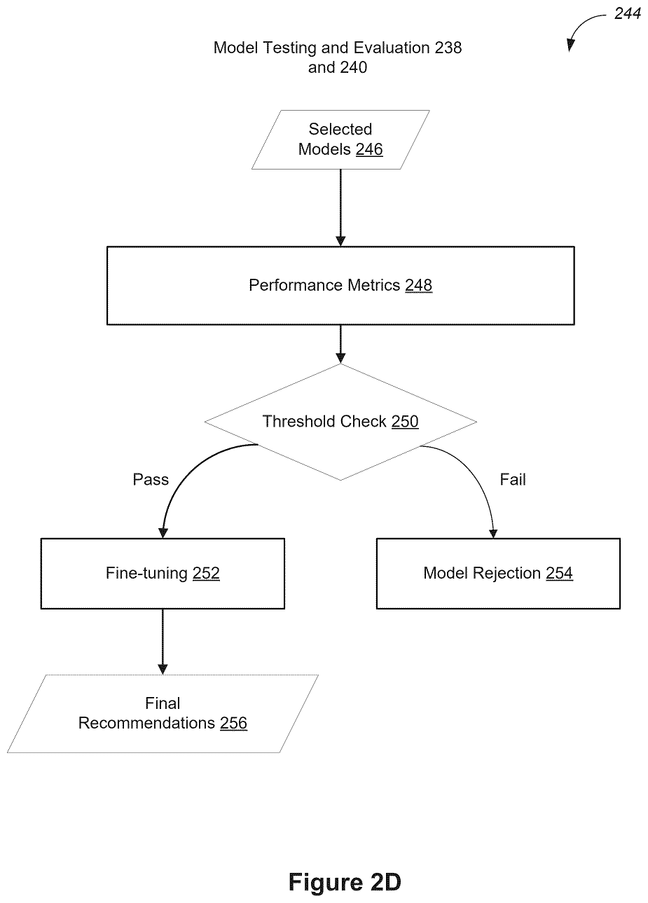

FIG. 2A is a schematic diagram of an example process for data labeling 200, according to some embodiments. The process is implemented by the data labeling module 104, which provides automated dataset understanding and classification. In some embodiments, the data labeling module 104 implements a dual-strategy approach: combining unsupervised learning for pattern detection with zero-shot generalized models for initial labeling. The process begins by large, generalized embedding models transforming raw input data 202 (sometimes referred to as raw datasets) into vector representations, capturing essential features and characteristics of the dataset, which is indicated by the step labeled feature extraction using embedded model 204. These embeddings then undergo analysis using techniques for unsupervised clustering 206, such as centroid-based, distribution-based, and hierarchical clustering algorithms, to identify natural groupings within the data. In some embodiments, the data labeling module 104 selects clustering algorithms based on data characteristics, for example: K-means for numerical data with clear centroids (e.g., silhouette score>0.6), DBSCAN for data with irregular cluster shapes (e.g., minimum points per cluster=5), and hierarchical clustering for nested structures. The optimal number of clusters can be determined using the elbow method and silhouette analysis, with a maximum number of clusters (e.g., 50 clusters) per dataset.

To optimize computational efficiency and ensure representative sampling, the data labeling module 104 performs strategic data point selection. The data labeling module 104 identifies both centrally located samples that best represent each cluster and outlier points that capture edge cases, which is indicated by the step labeled select representative points 208. This step creates a balanced subset of the data. This selected subset is then processed through large, generalized foundation models, such as GPT-based systems, which generate descriptive labels, objects, and keywords for each data point. The result is a sparsely but accurately labeled dataset 212 that captures a full spectrum of data characteristics while minimizing computational overhead.

FIG. 2B is a schematic diagram of an example process for resource prediction 214, according to some embodiments. The resource prediction module 106 uses telemetry data 216, current deployment data 218, and/or historical data 220, for resource predictions. The resource prediction module 106 functions as a dynamic monitoring and prediction system designed to assess computational resource availability within the deployment environment. In some embodiments, the module performs multi-tiered analysis of deployment parameters including compute capacity, memory utilization, latency requirements, and associated costs. By employing a Long Short-Term Memory (LSTM) neural network architecture 222, for example, the module 106 analyzes the telemetry data 216 collected from both historical data 220 and active deployments 218 across the existing infrastructure. This continuous analysis enables the modeling of application usage patterns and resource consumption trends across the deployment platform. The resource prediction module 106 maintains real-time awareness of system capabilities by generating ongoing resource availability forecasts 224 for configurable time periods, while simultaneously incorporating feedback (dynamic updates 226) from active model testing and selection processes to refine its predictions. Through this adaptive approach, the resource prediction module 106 ensures optimal resource allocation and utilization of compute resources 228 across system operations, enabling efficient scaling and deployment of selected AI models based on actual infrastructure capabilities.

In some embodiments, the resource prediction module 106 utilizes regression models trained on historical resource utilization data to forecast available computational capacity. The predictions can account for CPU usage, memory availability, network bandwidth, and/or storage I/O across varying time windows (e.g., from minutes to days). The LSTM networks can be trained on normalized telemetry data including, for example, CPU utilization percentages, memory usage in GB, network throughput in Mbps, and/or disk I/O operations per second.

In some embodiments, the resource prediction module 214 monitors and/or analyzes specific parameters including, for example, infrastructure metrics, temporal parameters, and/or resource availability thresholds. Infrastructure metrics can track CPU utilization (e.g., at one-minute intervals), memory usage (e.g., at five-minute intervals), GPU allocation by compute unit, and network bandwidth (e.g., at 30-second intervals). Prediction windows can be categorized as short-term (e.g., 5 -15 minutes), medium-term (e.g., 1-4 hours), and long-term (e.g., 24-72 hours). Resource availability can be classified as critical (e.g., below 10%), warning (e.g., between 10-25%), and optimal (e.g., above 25%). The resource prediction module 214 can combine these parameters using weighted averaging based on historical accuracy metrics.

FIG. 2C is a flow diagram of an example process for context-aware model selection 228, according to some embodiments. The process is implemented by the context-aware model selector 102. The process begins with a creating dataset step 230, which processes the labeled data received from the data labeling module 104. Following this, at step 232, a Large Language Model (LLM) summarizes the labeled dataset, extracting key contextual information including labels and keywords that characterize the data's nature. At step 234, the context-aware model selector 102 generates suitable models and tasks from this summary, leveraging an LLM trained on model cards and dataset contexts from AI model repositories, such as Hugging Face, OpenAI Model Zoo. For example, when processing insurance company data containing FAQs, documentation, and call records, the context-aware model selector 102 would identify relevant AI tasks, such as chatbot development, question-answering, and text generation, along with specific models like Meta-Llama-3.1-8B or c4ai-command-r-08-2024. These example models are not intended to be exhaustive or to limit the scope of the inventions to the precise examples disclosed, and many modifications and variations of the example models are possible in view of the above teachings.

In some embodiments, the model selection algorithm uses a weighted scoring system that combines multiple factors, for example: model performance metrics (e.g., 40% weight), resource utilization efficiency (e.g., 30% weight), and/or task-specific requirements (e.g., 30% weight). The selection process can filter models based on constraints like maximum memory usage and inference time limits, then rank remaining candidates using the weighted scoring system. The model selection algorithm can select models that meet minimum thresholds in different categories as viable candidates. The numerical examples mentioned herein are not intended to be exhaustive or to limit the scope of the inventions to the precise examples disclosed, and many modifications and variations of the example models are possible in view of the above teachings.

The context-aware model selector 102 then incorporates compute resources 228 into the decision-making process. At step 236, the context-aware model selector 102 selects models based on resource tier constraints, filtering the previously identified models according to available computational resources. The context-aware model selector 102 subsequently tests (238) the selected models on the labeled dataset, which serves as ground truth, measuring key performance indicators (KPIs), such as F1 score, accuracy, and precision. At decision point 240, the context-aware model selector 102 evaluates whether the measured KPIs meet acceptable thresholds, using a tunable parameter (such as 90% accuracy). If the KPIs are acceptable, the flow proceeds to step 242, where the system makes final model recommendations 242. These recommendations can include comprehensive deployment specifications, such as model details, latency requirements, memory usage, CPU requirements, and model size. In this way, the context-aware model selector 102 integrates dataset characteristics, available resources, and performance requirements to make informed model selection decisions, functioning as the decision-making component of the system 100 while interfacing with both public and private AI model repositories.

FIG. 2D shows an example model testing and evaluation process 244, according to some embodiments. The process corresponds to the steps 238 and 240 in FIG. 2C, and is performed by the context-aware model selector 102. The process begins with selected models 246, which represents the input of candidate models identified by the context-aware model selector 102. These models proceed to performance metrics step 248, where the system conducts rigorous evaluation using the labeled dataset as ground truth. During this phase, the system calculates crucial performance indicators including F1 score, accuracy, and precision, while considering specific deployment constraints and task requirements. At the threshold check decision point 250, the system evaluates whether the calculated performance metrics meet predefined acceptable thresholds. The flow then branches into two possible paths based on this evaluation. Along the “Pass” path, models meeting the performance criteria proceed to fine-tuning step 252, where additional optimization is performed to improve accuracy and reduce potential hallucinations. Models failing to meet the threshold requirements follow the “Fail” path to model rejection 254, removing them from further consideration. The process concludes at final recommendations 256, where successful models that have undergone fine-tuning are presented as deployment candidates, complete with their performance characteristics and optimization results. This systematic evaluation and optimization process ensures that only models meeting both performance requirements and deployment constraints are recommended for implementation.

In some embodiments, the context-aware model selector 102 implements a structured process for determining performance thresholds. Historical performance analysis of similar models in the domain provides baseline thresholds. These thresholds are then dynamically adjusted based on input data quality metrics and task-specific minimum requirements. For example, classification tasks in critical applications like medical diagnosis require an F1 score of 0.95 or higher, while general text classification may accept thresholds of 0.85. A configuration matrix can map specific thresholds to different task types. For example, critical domain tasks require 0.95 or higher F1 score and 0.98 precision, general classification tasks require 0.85 or higher F1 score and 0.90 precision, and experimental applications accept 0.80 or higher F1 score and 0.85 precision. These thresholds can be maintained in a configuration database and updated based on deployment feedback and evolving domain requirements.

In some embodiments, the context-aware model selector 102 implements specific quantitative thresholds for different model types and applications. For example, for classification tasks, minimum acceptable thresholds are: F1 score≥0.85, precision≥0.90, and recall≥0.85. For regression tasks: R-squared≥0.80 and RMS≤domain-specific maximum error tolerance. For generation tasks: BLEU score≥0.70 and perplexity≤3.0. Critical applications like medical diagnosis can use higher thresholds (e.g., F1 score≥0.95 and precision≥0.98).

In some embodiments, the context-aware model selector implements confidence scoring for model recommendations. For critical applications, for example, models must achieve a minimum confidence score (e.g., 0.95) across all evaluation metrics, while general applications may accept a lower confidence score (e.g., 0.85). The confidence score can be calculated using a weighted average of performance metrics, resource utilization efficiency, and model reliability scores derived from historical deployment data. Models that achieve high performance but low confidence scores can be flagged for additional validation testing before being recommended for deployment. The system can maintain separate confidence thresholds for different application domains (e.g., medical applications requiring 0.98, financial applications requiring 0.95, and general applications requiring 0.90).

The numerical examples mentioned with reference to FIG. 2D are not intended to be exhaustive or to limit the scope of the inventions to the precise examples disclosed, and many modifications and variations of the example models are possible in view of the above teachings.

In some embodiments, the context-aware model selector uses a hierarchical decision framework that evaluates multiple criteria. Primary criteria can include, for example, performance metric achievements above established thresholds, efficient resource requirements, and/or response time compliance. Secondary evaluation factors can include, for example, the trade-off between model size and performance as well as two key metrics: resource utilization efficiency and model reliability scores. Resource utilization efficiency measures how effectively a model uses allocated computing resources. This includes the ratio of throughput (requests processed) to CPU/GPU utilization, memory usage optimization (e.g., maintaining peak memory usage below 80% of allocated memory), and energy efficiency metrics such as operations per watt. Model reliability scores can be derived from consistency of predictions across multiple runs, stability of performance under varying load conditions, error rate patterns in production environments, and/or mean time between prediction failures. The framework can also consider inference time stability, which measures consistency in response times. The context-aware model selector 102 can maintain detailed logs documenting performance analysis, which can enable continuous improvement of the selection process. Models that perform below standard thresholds but demonstrate promising efficiency metrics may be flagged for potential fine-tuning rather than immediate dismissal.

In some embodiments, model rejection follows a hierarchical decision framework evaluating multiple criteria. Primary rejection criteria can include, for example, performance metric failures below established thresholds, excessive resource requirements, and/or response time violations. Secondary evaluation factors can include, for example, the trade-off between model size and performance, memory utilization efficiency, and/or inference time stability. The context-aware model selector 102 can maintain detailed rejection logs documenting failure analysis, which can enable continuous improvement of the selection process. Models that fail performance thresholds but demonstrate promising efficiency metrics may be flagged for potential fine-tuning rather than immediate rejection, for example.

In some embodiments, the context-aware model selector 102 defines acceptable performance through comprehensive metric frameworks for different task types. For example, classification tasks must achieve an F1 score of 0.85 or higher and precision of 0.90 or higher. Regression tasks require an R-squared value of 0.80 or higher and RMSE below task-specific thresholds. Generation tasks must achieve a BLEU score of 0.70 or higher with perplexity below 3.0. Additional performance indicators can include inference time under 100 milliseconds for real-time applications, memory efficiency within specified RAM thresholds, and batch processing capability of at least 1,000 samples per second. Domain-specific requirements can include, for example, sensitivity of 0.95 or higher and specificity of 0.98 or higher for medical applications, precision of 0.95 or higher and recall of 0.90 or higher for financial applications, and balanced accuracy of 0.85 or higher for general purpose applications.

In some embodiments, the system implements a multi-stage validation pipeline for recommended models. For example, in a first stage, models undergo synthetic load testing with simulated data to verify performance under varying load conditions. A second stage can include adversarial testing where models are evaluated against edge cases and potential attack vectors. A third stage can include stability testing under sustained load, requiring models to maintain consistent performance metrics over extended operation periods (e.g., at least 72 hours). Models must pass all the stages with a minimum success rate (e.g., 95%) to be considered for production deployment. The validation results can be stored in a performance history database that informs future model selection decisions.

In some embodiments, a recommendation engine (as part of the context-aware model selector 102) synthesizes the outputs from previous modules to generate optimized model selections. This engine considers both performance metrics and resource constraints to suggest the most suitable models for deployment. In cases where input datasets span multiple domains or topics, the engine can recommend (e.g., using the data labeling module to explain using embedding and large models) combinations of generalized and specialized models, optimizing for both broad coverage and domain-specific expertise. In some embodiments, the system also includes a fine-tuning module that can further optimize recommended models to improve accuracy and reduce potential hallucinations. The fine-tuning process includes, for example, iterative model optimization using a subset of the input dataset as a validation set. The system can use gradient-based optimization with early stopping based on validation loss. Learning rates can be automatically adjusted using a cosine decay schedule. The process terminates when either the validation metrics improve by less than a predetermined percentage (e.g., 0.1%) over a predetermined number of epochs (e.g., 3 consecutive epochs) or after a predetermined maximum number of epochs (e.g., 50 epochs) is reached.

In some embodiments, for enhanced efficiency, particularly when dealing with large-scale datasets, the system 100 is designed to operate in proximity to data storage systems. This architectural choice minimizes data transfer overhead and enables efficient analysis of substantial datasets. The system 100 also incorporates adaptive capabilities, dynamically adjusting selection criteria based on deployment feedback and evolving resource availability. When processing multimodal data including text, images, and audio, the system employs modality-specific feature extractors to ensure optimal processing across different data types.

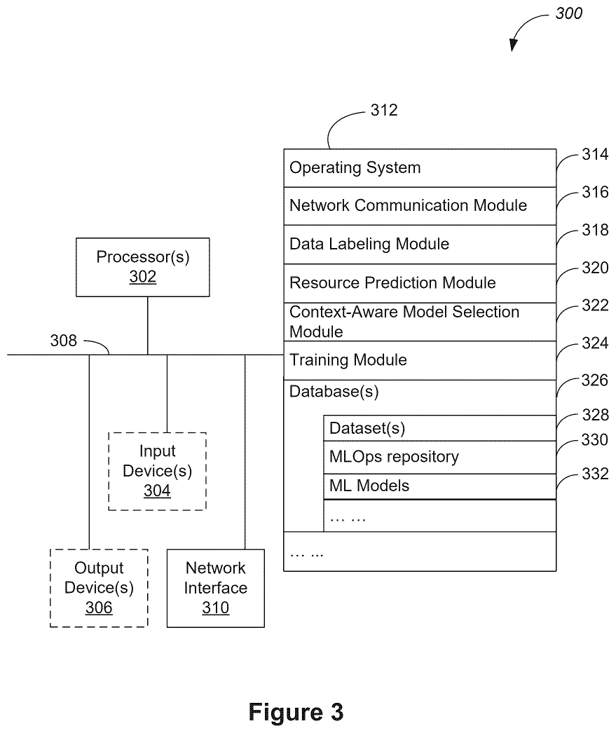

FIG. 3 shows a block diagram of an example computing device 300 for optimizing artificial intelligence (AI) model selection and loading, according to some embodiments. The computing device 300 includes one or more processors 302 for executing instructions and processing data. These may include CPUs, GPUs, and/or specialized processors for tasks like image processing. The computing device 300 also includes a memory 312, a storage for data and instructions, which may include high-speed random access memory and non-volatile storage like flash memory or solid-state drives. The computing device 300 also includes a communication bus 308, which may include one or more interconnects connecting the various hardware components, allowing data transfer between them. The computing device 200 may also include communication interface(s) 310, which enable network connectivity, potentially including Wi-Fi, Bluetooth, or wired connections for data transfer and API communications. The computing device 300 may also include input devices 304 shown as an optional component (dashed lines), which may include controllers, hand-tracking sensors, and/or other mechanisms for user interaction. The computing device 300 may also include one or more output devices 306 (e.g., a display). The computing device 300 may also include power supply, for providing power to the system, which may be a battery for portable use or a connection to a main power.

In some embodiments, the memory 312 includes high-speed random access memory, such as DRAM, SRAM, DDR RAM, and/or other random access solid state memory devices. In some embodiments, the memory 312 includes non-volatile memory, such as one or more magnetic disk storage devices, optical disk storage devices, flash memory devices, or other non-volatile solid state storage devices. In some embodiments, the memory 312 includes one or more storage devices remotely located from the processor(s) 302. The memory 312, or alternatively the non-volatile memory device(s) within the memory 312, comprises a computer readable storage medium. Memory for headsets include, for example, Random Access Memory (RAM), such as Low Power Double Data Rate RAM (LPDDR), used for running the operating system, applications, and/or handling real-time data processing. The memory 312 may also include storage memory, such as flash memory, similar to smartphones (e.g., eMMC or UFS), for storing the operating system, applications, and/or user data. Video memory, often integrated with the GPU in mobile chipsets, can be used to handle graphics processing tasks. Cache memory, such as Static RAM (SRAM), can be used for high-speed memory used by the processors 302 for data access.

In some implementations, the memory 312 stores one or more programs (e.g., sets of instructions), and/or data structures, collectively referred to as “modules” herein. In some implementations, the memory 312, or the non-transitory computer readable storage medium of the memory 312, stores the following programs, modules, and data structures, or a subset or superset thereof:
on operating system 314, which manages system resources and/or processes, and/or provide a platform for other software components;
a network communications module 316, which handles network communications, may be using protocols suitable for real-time data exchange;
a data labeling module 318 (e.g., the data labeling module 104);
a resource prediction module 320 (e.g., the resource module 106);
a context-aware model selection module 322 (e.g., the context-aware model selector 102);
an optional training module 324 (e.g., the training module 108) for training AI models selected by the context-aware model selector 102; and/or
databases 326, which includes datasets 328 (e.g., the dataset 114), MLOps repository 330 (e.g., the MLOps repo 116), and/or ML models 332 (e.g., the foundation models 110).

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise rearranged in various implementations. In some embodiments, the memory 312 stores a subset of the modules and data structures identified above. Furthermore, in some embodiments, the memory 312 stores additional modules or data structures not described above. Example details and/or operations of the modules, data structures, applications and/or procedures, are further described below, according to some embodiments. Although FIG. 3 shows a computing device, FIG. 3 is intended more as a functional description of the various features that may be present rather than as a structural schematic of the implementations described herein. In practice, and as recognized by those of ordinary skill in the art, items shown separately could be combined and some items could be separated.

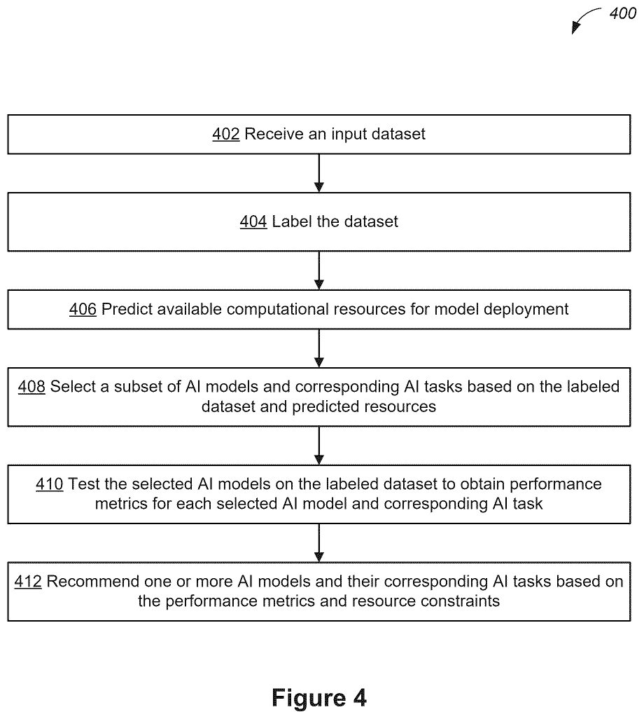

FIG. 4 is a flowchart of an example method 400 for autonomous context-aware selection of artificial intelligence (AI) models, according to some embodiments. The method is performed by the computing system 300 having one or more processors 302, and memory 312 storing one or more programs configured for execution by the one or more processors 302.

The network communications module 316 receives (402) an input dataset 328. The data labeling module 318 labels (404) the input dataset, using at least one of unsupervised learning techniques and zero-shot generalized models (e.g., the ML models 332). In some embodiments, the data labeling module 318 extracts features using a large, generalized embeddings model through feature extraction 204, clusters these features using unsupervised learning techniques 206 (e.g., clustering), selects representative points 208 and outliers from the clusters, and generates labels using the ML models 332. The large, generalized embedding model can include models to create vector representations (embeddings) of input data, and/or models used for feature extraction and/or dimensionality reduction, which may include BERT, Word2Vec, or CLIP for image. For generating labels, models trained on data to perform a wide range of tasks can be used. These models can generate text, answer questions, and perform various other tasks beyond just creating embeddings. Examples of these models include GPT-3, PaLM, or BLOOM. Combining large, generalized models for feature extraction and labeling with unsupervised clustering and strategic point selection, can leverage transfer learning and potentially reduces computational costs.

In some embodiments, the one or more unsupervised learning techniques includes at least one of: centroid-based, distribution-based, and hierarchical clustering algorithms. Some embodiments analyze the characteristics of different subsets within the dataset (e.g., data type, distribution, dimensionality), and/or dynamically select the most appropriate clustering algorithm for each subset, such as using K-means for numeric data with clear centroids, hierarchical clustering for data with nested structures, or density-based clustering for data with irregular shapes.

In some embodiments, the computing system 300 skips the data labeling step for pre-labeled datasets, and directly inputs the labeled dataset to the context-aware model selection module 322. In some embodiments, the input dataset 328 includes multimodal data, such as text, images, and audio, and the data labeling module 318 uses modality-specific feature extractors for different types of data

The resource prediction module 320 predicts (406) available computational resources (e.g., in real-time) by analyzing telemetry data 216 from current deployment data 218 and historical data 220. In some embodiments, the resource prediction module 320 employs an LSTM network 222 to analyze telemetry data 216 from deployments in the distributed computing environment. In some embodiments, the resource prediction module 320 models usage patterns, generates resource availability forecasts 224, and incorporates dynamic updates 226 based on ongoing testing. LSTM is only an example. In addition to, or instead of, LSTM network 222, predictive analytics methods can be applied on historic telemetry data. The predictive analytics methods can include statistical algorithms like Autoregressive Integration Moving Average (ARIMA), or deep learning methods like recurrent neural networks (RNNs).

The context-aware model selection module 322 selects (408) a subset of AI models and corresponding AI tasks based on the labeled dataset and predicted compute resources 228. In some embodiments, the module 322 summarizes the labeled dataset using an LLM (e.g., the step 232) and queries the MLOps repository 330 to return suitable AI models and tasks (e.g., the step 234). In some embodiments, the MLOps repository 330 includes at least one public repository and one or more public or private repositories. Public repositories typically include application programming interfaces (APIs) making model cards that are available to retrieve.

The context-aware model selection module 322 tests (410) these selected models on the labeled dataset to obtain performance metrics for each selected AI model and corresponding AI task. In some embodiments, the context-aware model selection module 322 tests the selected models by running each model on the labeled dataset at step 238, calculates performance metrics 248 (e.g., F1 score, accuracy, precision), and compares (e.g., the step 250) the metrics to a tunable threshold. The threshold can be adjusted based on deployment constraints. For example, when deploying on edge devices with limited computational resources, a lower accuracy threshold may be acceptable to accommodate quantized models that trade some accuracy for reduced model size and faster inference. Subsequently, the context-aware model selection module 322 recommends one or more AI models and their corresponding AI tasks based on the performance metrics and resource constraints.

In some embodiments, the context-aware model selection module 322 dynamically adjusts selection criteria based on dynamic updates 226 from deployed models and resource changes. In some embodiments, storage optimization quality recommendations are determined through performance metrics and requirements. Storage performance metrics can include, for example, read/write latency (e.g., under 10 milliseconds) for critical operations, input/output operations per second (IOPS) requirements specified according to model size, and storage bandwidth utilization (e.g., utilization maintained below 80% of available capacity). In some embodiments, data access patterns are analyzed for sequential versus random access requirements, batch size optimization, and/or caching strategy recommendations. In some embodiments, storage resource allocation considers the ratio of model size to storage capacity, temporary storage requirements for inference operations, and/or backup and redundancy requirements. In some embodiments, the computing system 300 continuously monitors these metrics to maintain optimal storage performance and generates recommendations for ongoing optimization.

In some embodiments, model deployment validation can include specific infrastructure compatibility checks. The system can verify hardware compatibility across different GPU architectures, for example, ensuring models maintain specified performance characteristics across different deployment environments. Memory utilization can be tested under various batch sizes, from single-instance inference to batch sizes of 1024, with requirements for linear scaling up to target batch sizes. Network bandwidth requirements can be validated through simulation of concurrent model serving requests, ensuring latency remains under a threshold (e.g., 100 milliseconds) at peak load. The validation process can include automated generation of deployment configuration files optimized for the target infrastructure.

In some embodiments, the context-aware model selection module 322 queries multiple public AI model repositories 330 simultaneously. In some embodiments, the context-aware model selection module 322 generates dataset summaries using an LLM at step 232, formulates prompts for querying model repositories 330, and verifies summary relevance. In some embodiments, for multi-domain datasets, the context-aware model selection module 322 selects specialized models for each domain and recommends combinations of generalized and specialized models based on dataset composition.

In some embodiments, the training module 324 fine-tunes recommended models at step 252 to improve accuracy and reduce hallucinations. In some embodiments, when operating with datasets 328 stored in the memory 312, the computing system 300 optimizes storage performance through efficient model selection. In some embodiments, the computing system 300 operates in proximity to memory 312, enabling efficient analysis and model selection for large datasets without requiring data transfer to separate computing resources.

In this way, the method 400 and the computing system 300 provide concrete technological improvements by automating and optimizing the complex process of AI model selection through computational techniques that would be impractical to perform manually. For example, by combining automated data labeling using foundation models, real-time infrastructure resource analysis via LSTM networks, systematic model evaluation from public repositories, and performance testing against configurable thresholds, the method 400 achieves efficiency gains in both computational overhead and resource allocation. These techniques eliminate the complexity of model selection while ensuring optimal task-specific performance, resulting in reduced infrastructure costs and improved processing efficiency for enterprise deployments.

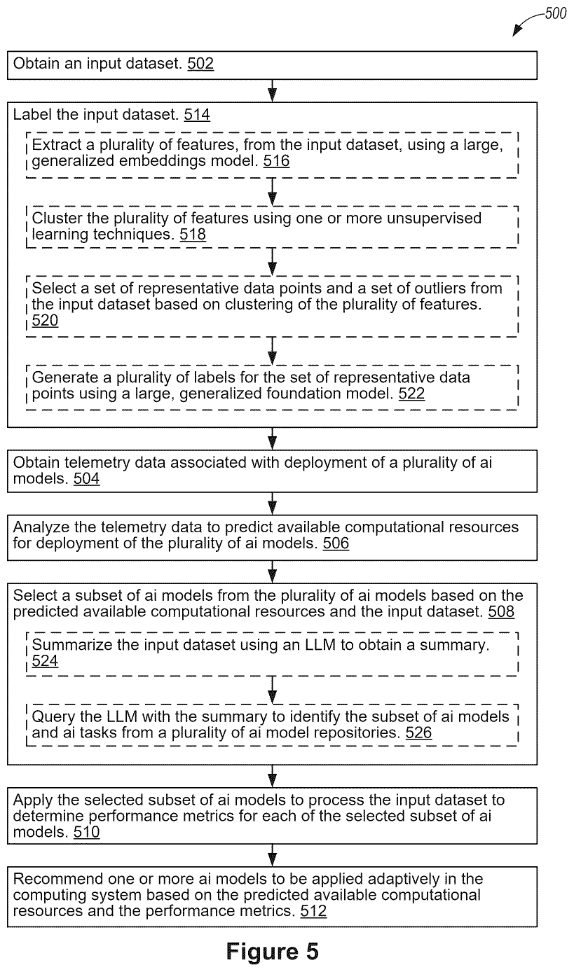

FIG. 5 is a flowchart of another example method 500 for autonomous context-aware selection of AI models, according to some embodiments. For convenience, the method 500 is described as being implemented by a computing system 300. The computing device 300, through its processor(s) 302 and memory 312, executes a method that reduces video data storage and improves processing efficiency. Method 500 is, optionally, governed by instructions that are stored in a non-transitory computer readable storage medium and that are executed by one or more processors of the computing system. Each of the operations shown in FIG. 5 may correspond to instructions stored in a computer memory or non-transitory computer readable storage medium (e.g., memory 312 in FIG. 3). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 500 may be combined and/or the order of some operations may be changed.

The computing system 300 obtains (operation 502) an input dataset 114. The computing system 300 collects (operation 504) telemetry data 216 associated with deployment of a plurality of AI models, and analyzes (operation 506) the telemetry data 216 to predict available computational resources 228 for deployment of the plurality of AI models. A subset of AI models 246 is selected (operation 508) from the plurality of AI models based on the predicted available computational resources 228 and the input dataset 114, and applied (operation 510) to process the input dataset 114 to determine performance metrics 248 for each of the selected subset of AI models 246. The computing system 300 recommends (operation 512) one or more AI models (e.g., final recommendations 256 in FIG. 2D) to be applied adaptively in the computing system 300 based on the predicted available computational resources 228 and the performance metrics 248.

In some embodiments, the computing system 300 labels (operation 514) the input dataset 114. For example, the computing system 300 extracts (operation 516) a plurality of features, from the input dataset 114, using a large, generalized embeddings model, clusters (operation 518) the plurality of features using one or more unsupervised learning techniques, selects (operation 520) a set of representative data points and a set of outliers from the input dataset 114 based on clustering of the plurality of features, and generates (operation 522) a plurality of labels 212 for the set of representative data points using a large, generalized foundation model. Further, in some embodiments, the one or more unsupervised learning techniques include at least one of: a centroid-based clustering method, a distribution-based clustering method, and a hierarchical clustering method. In some embodiments, the input dataset 114 and the one or more labels 212 are applied to determine the performance metrics 248 for each of the selected subset of AI models 246.

In some embodiments, the computing system 300 collects the telemetry data 216 from past and current deployments implemented in a distributed computing environment, and a predictive analytics technique is applied to analyze the telemetry data 216. In some embodiments, the computing system 300 includes a resource prediction module 106 configured to apply a predictive analytics technique to analyze the telemetry data 216 to predict the available computational resources 228.

In some embodiments, the subset of AI models 246 is selected with one or more corresponding AI tasks. The computing system 300 selects the subset of AI models 246 by summarizing (operation 524) the input dataset 114 using a Large Language Model (LLM) to obtain a summary and querying (operation 526) the LLM with the summary to identify the subset of AI models 246 and AI tasks from a plurality of AI model repositories. Further, in some embodiments, the plurality of AI model repositories includes at least one public repository and one or more public or private repositories.

In some embodiments, when the computing system 300 applies the selected subset of AI models 246, the computing system 300 runs each of the one or more AI models on the input dataset 114, determines performance metrics 248 including an F1 score, an accuracy level, and a precision level, and compares the performance metrics 248 to a tunable threshold parameter. Further, in some embodiments, the computing system 300 further includes a testing module to apply the selected subset of AI models 246.

In some embodiments, the computing system 300 fine-tunes the one or more AI models based on the input dataset 114 to improve an accuracy level, and reduce hallucinations, of the one or more AI models. In some embodiments, the computing system 300 further includes a fine-tuning module 252 (FIG. 2D) configured to fine-tune the one or more AI models.

In some embodiments, the input dataset 114 is pre-labeled and used to determine the performance metrics 248 for the selected subset of AI models 246 and select the one or more AI models.

In some embodiments, the input dataset 114 includes multimodal data further including text, images, and audio. The computing system 300 extracts modality-specific features of the multimodal data based on associated data types, and labels the input dataset 114 using an unsupervised learning technique or a zero-shot generalized model based on the modality-specific features of the multimodal data. In some embodiments, the computing system 300 further includes a data labeling module 104 configured to label the input dataset 114 using the unsupervised learning technique or the zero-shot generalized model.

In some embodiments, the subset of AI models 246 is selected based on a selection criterion. The computing system 300 obtains a feedback associated with a deployed AI model, determines a change of the available computational resources 228, and dynamically adjusts the selection criterion based on the feedback associated with the deployed AI model and the change of the available computational resources 228.

In some embodiments, the plurality of AI models are stored in a plurality of public AI model repositories, and the computing system 300 selects the subset of AI models 246 by querying, via a context-aware model selector 102, the plurality of public AI model repositories simultaneously.

In some embodiments, the input dataset 114 and the telemetry data 216 are stored on solid-state drives (SSDs), and the computing system 300 is an SSD-based memory system, and the method is implemented on the SSD-based memory system, thereby improving storage performance by providing quality recommendations for AI models based on the stored data.

In some embodiments, the computing system 300 generates a summary of the input dataset 114 using an LLM, and uses the summary to formulate a prompt for querying a plurality of AI model repositories via a context-aware model selector 102 to select at least the subset of AI models 246.

In some embodiments, when the computing system 300 predicts the available computational resources 228, the computing system 300 models one or more usage patterns of one or more applications running on a deployment platform, predicts the available computational resources 228 for an upcoming time window, and dynamically updates prediction of the available computational resources 228 based on a determination of the performance metrics 248 and a selection of the one or more AI models. In some embodiments, the computing system 300 further includes a resource prediction module 106 configured to predict the available computational resources 228.

In some embodiments, in accordance with a determination that the input dataset 114 contains data corresponding to a plurality of domains, the computing system 300 selects one or more specialized models for each of the plurality of domains, and recommends a combination of a generalized model and a plurality of specialized models based on the plurality of domains of the input dataset 114.

In some embodiments, the computing system 300 further includes a context-aware model selector configured to apply an LLM trained on a plurality of AI model repositories to select the one or more AI models.

In some embodiments, the computing system 300 further includes a fine-tuning module 252 (FIG. 2D) configured to improve an accuracy level, and reduce a hallucination level, of each of the one or more AI models based on the input dataset 114.

In some embodiments, the input dataset 114 is pre-labeled and used to determine the performance metrics 248 for the selected subset of AI models 246 and select the one or more AI models.

In some embodiments, the computing system 300 further includes a context-aware model selector configured to generate a summary of the input dataset 114 using an LLM, use the summary to formulate a prompt for querying a plurality of AI model repositories, retrieve information about a set of candidate models from the plurality of AI model repositories, determine a respective relevance level with respect to the summary for each candidate model, and select the subset of AI models 246 based on the retrieved information and the respective relevance levels of the set of candidate models.

In some embodiments, the computing system 300 is configured to operate in proximity to a data storage system, and the input dataset 114 and the telemetry data 216 are stored in the data storage system, thereby enabling efficient analysis and model selection for large datasets without requiring data transfer to separate computing resources.

It should be understood that the particular order in which the operations in FIG. 5 have been described are merely exemplary and are not intended to indicate that the described order is the only order in which the operations could be performed. One of ordinary skill in the art would recognize various ways to select and load AI models. Additionally, it should be noted that details of other processes described above with respect to FIGS. 1-4 are also applicable in an analogous manner to method 500 described above with respect to FIG. 5. For brevity, these details are not repeated here.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

The foregoing description, for purpose of explanation, has been described with reference to specific implementations. However, the illustrative discussions above are not intended to be exhaustive or to limit the scope of the claims to the precise forms disclosed. Additionally, the foregoing description, for purpose of explanation, has been described with reference to specific numerical examples (e.g., associated with performance metrics, resource utilization efficiency, and/or task-specific requirements). However, the illustrative discussions above are not intended to be exhaustive or to limit the scope of the claims to the precise numerical examples disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A computer-implemented method for selecting artificial intelligence (AI) models, comprising:
at a computing system including one or more processors and memory:
obtaining an input dataset;
obtaining telemetry data associated with deployment of a plurality of AI models;
analyzing the telemetry data to predict available computational resources for deployment of the plurality of AI models;
selecting a subset of AI models from the plurality of AI models based on the predicted available computational resources and the input dataset;
applying the selected subset of AI models to process the input dataset to determine performance metrics for each of the selected subset of AI models; and
recommending one or more AI models to be applied adaptively in the computing system based on the predicted available computational resources and the performance metrics.

2. The method of claim 1, further comprising labeling the input dataset comprises:
extracting a plurality of features, from the input dataset, using a large, generalized embeddings model;
clustering the plurality of features using one or more unsupervised learning techniques;
selecting a set of representative data points and a set of outliers from the input dataset based on clustering of the plurality of features; and
generating a plurality of labels for the set of representative data points using a large, generalized foundation model.

3. The method of claim 2, wherein the one or more unsupervised learning techniques include at least one of: a centroid-based clustering method, a distribution-based clustering method, and a hierarchical clustering method.

4. The method of claim 1, further comprising:
collecting the telemetry data from past and current deployments implemented in a distributed computing environment, wherein a predictive analytics technique is applied to analyze the telemetry data.

5. The method of claim 1, wherein the subset of AI models is selected with one or more corresponding AI tasks, and selecting the subset of AI models further comprises:
summarizing the input dataset using a Large Language Model (LLM) to obtain a summary; and
querying the LLM with the summary to identify the subset of AI models and AI tasks from a plurality of AI model repositories.

6. The method of claim 5, wherein the plurality of AI model repositories includes at least one public repository and one or more public or private repositories.

7. The method of claim 1, wherein applying the selected subset of AI models further comprises:
running each of the one or more AI models on the input dataset;
determining performance metrics including an F1 score, an accuracy level, and a precision level; and
comparing the performance metrics to a tunable threshold parameter.

8. The method of claim 1, further comprising fine-tuning the one or more AI models based on the input dataset to improve an accuracy level, and reduce hallucinations, of the one or more AI models.

9. The method of claim 1, wherein the input dataset is pre-labeled and used to determine the performance metrics for the selected subset of AI models and select the one or more AI models.

10. The method of claim 1, wherein the input dataset includes multimodal data further including text, images, and audio, the method further comprising:
extracting modality-specific features of the multimodal data based on associated data types; and
labeling the input dataset using an unsupervised learning technique or a zero-shot generalized model based on the modality-specific features of the multimodal data.

11. The method of claim 1, wherein the subset of AI models is selected based on a selection criterion, the method further comprising:
obtaining a feedback associated with a deployed AI model;
determining a change of the available computational resources;
dynamically adjusting the selection criterion based on the feedback associated with the deployed AI model and the change of the available computational resources.

12. The method of claim 1, wherein the plurality of AI models are stored in a plurality of public AI model repositories, and selecting the subset of AI models further comprises querying, by a context-aware model selector, the plurality of public AI model repositories simultaneously.

13. The method of claim 1, wherein the input dataset and the telemetry data are stored on solid-state drives (SSDs), and the computing system is an SSD-based memory system, and the method is implemented on the SSD-based memory system.

14. The method of claim 1, further comprising:
generating a summary of the input dataset using a Large Language Model (LLM); and
using the summary to formulate a prompt for querying a plurality of AI model repositories via a context-aware model selector to select at least the subset of AI models.

15. The method of claim 1, wherein predicting the available computational resources comprises:
modelling one or more usage patterns of one or more applications running on a deployment platform;
predicting the available computational resources for an upcoming time window; and
dynamically updating prediction of the available computational resources based on a determination of the performance metrics and a selection of the one or more AI models.

16. The method of claim 1, further comprising:
in accordance with a determination that the input dataset contains data corresponding to a plurality of domains:
selecting one or more specialized models for each of the plurality of domains; and
recommending a combination of a generalized model and a plurality of specialized models based on the plurality of domains of the input dataset.

17. A computing system for autonomous context-aware AI model selection, the computing system comprising:
one or more processors; and
memory storing one or more programs configured for execution by the one or more processors, the one or more programs comprising instructions for:
obtaining an input dataset;
obtaining telemetry data associated with deployment of a plurality of AI models;
analyzing the telemetry data to predict available computational resources for deployment of the plurality of AI models;
selecting a subset of AI models from the plurality of AI models based on the predicted available computational resources and the input dataset;
applying the selected subset of AI models to process the input dataset to determine performance metrics for each of the selected subset of AI models; and
recommending one or more AI models to be applied adaptively in the computing system based on the predicted available computational resources and the performance metrics.

18. The computing system of claim 17, further comprising one or more of:
a data labeling module configured to extract a plurality of features from the input dataset using a large, generalized embeddings model, cluster the plurality of features, select a set of representative data points and a set of outliers from the clusters, and generate one or more labels for the set of representative data points using a large, generalized foundation model, wherein the input dataset and the one or more labels are applied to determine the performance metrics for each of the selected subset of AI models;
a resource module configured to apply a predictive analytics technique to analyze the telemetry data to predict the available computational resources;
a context-aware model selector configured to apply a Large Language Model (LLM) trained on a plurality of AI model repositories to select the one or more AI models;
a testing module configured to run each of the one or more AI models on the input dataset, calculate performance metrics including an F1 score, an accuracy level, and a precision level, and compare the performance metrics to a tunable threshold parameter; and
a fine-tuning module configured to improve an accuracy level, and reduce a hallucination level, of each of the one or more AI models based on the input dataset;
a data labeling module configured to label the input dataset using an unsupervised learning technique or a zero-shot generalized model, wherein the input dataset includes multimodal data further including text, images, and audio;
a context-aware model selector configured to generate a summary of the input dataset using a Large Language Model (LLM); use the summary to formulate a prompt for querying a plurality of AI model repositories; in response to the prompt, retrieve information about a set of candidate models from the plurality of AI model repositories; determine a respective relevance level with respect to the summary for each candidate model; and select the subset of AI models based on the retrieved information and the respective relevance levels of the set of candidate models; and
a resource module configured to model one or more usage patterns of one or more applications running on a deployment platform, predict the available computational resources for an upcoming time window, and dynamically update prediction of the available computational resources based on a determination of the performance metrics and a selection of the one or more AI models.

19. A non-transitory computer-readable storage medium storing one or more programs configured for execution by one or more processors of a computing system for automatic context-aware AI model selection, the one or more programs comprising instructions for:
obtaining an input dataset;
obtaining telemetry data associated with deployment of a plurality of AI models;
analyzing the telemetry data to predict available computational resources for deployment of the plurality of AI models;
selecting a subset of AI models from the plurality of AI models based on the predicted available computational resources and the input dataset;
applying the selected subset of AI models to process the input dataset to determine performance metrics for each of the selected subset of AI models; and
recommending one or more AI models to be applied adaptively in the computing system based on the predicted available computational resources and the performance metrics.

20. The non-transitory computer-readable storage medium of claim 19, wherein the input dataset is pre-labeled and used to determine the performance metrics for the selected subset of AI models and select the one or more AI models; and the computing system is configured to operate in proximity to a data storage system, and the input dataset and the telemetry data are stored in the data storage system.
